(19) United States
(12) Patent Application Publication
(10) Pub. No.: US 2024/0098120 A1
(43) Pub. Date: Mar. 21, 2024

(54) APPLICATION CAPABILITY DISCOVERY AND ESTABLISHMENT ON A COMMUNICATION NETWORK

(71) Applicant: AT&T Intellectual Property I, L.P., Atlanta, GA (US)

(72) Inventors: Min Lu, Holmdel, NJ (US); Chaoxin Qiu, Austin, TX (US)

(73) Assignee: AT&T Intellectual Property I, L.P., Atlanta, GA (US)

(21) Appl. No.: 18/469,680

(22) Filed: Sep. 19, 2023

Related U.S. Application Data
(60) Provisional application No. 63/410,935, filed on Sep. 28, 2022.
(60) Provisional application No. 63/407,953, filed on Sep. 19, 2022.

(51) Int. Cl. H04L 65/1069; H04L 67/02; H04L 67/51

(52) U.S. Cl. CPC H04L 65/1069; H04L 67/02; H04L 67/51

(57) ABSTRACT

Aspects of the subject disclosure may include, for example, generating prioritized lists of OTT applications for end user devices, exchanging or otherwise providing the prioritized list(s) to enable analysis and comparison resulting in a selection of an OTT application, and establishing a communication service via the selected OTT application between the end user devices. Other embodiments are disclosed.

### CROSS REFERENCE TO RELATED APPLICATION(S)

This application claims the benefit of priority to U.S. Provisional Application No. 63/410,935, filed on Sep. 28, 2022 and claims the benefit of priority to U.S. Provisional Application No. 63/407,953, filed on Sep. 19, 2022. All sections of the aforementioned application(s) and/or patent(s) are incorporated herein by reference in their entirety.

### FIELD OF THE DISCLOSURE

The subject disclosure relates to application capability discovery and establishment on a communication network.

### BACKGROUND

There are many Over-The-Top (OTT) applications (e.g., voice) existing today. These OTT applications can execute in a best effort mode on top of traditional telecom providers' data networks. These OTT applications are generally a community-based service which have limited interoperability with outside communities. Some OTT applications are feature rich with enhanced multimedia capability. It is contemplated that in the future, OTT applications will evolve to include AR/VR/XR capability. Typically, a user installs different OTT applications on their phones or other devices and then uses different OTT applications to communicate with different people since different communities/devices have different capabilities. Individuals do not know the OTT application availability/capability of other parties unless information is exchanged beforehand by other means such as email, calling them, etc. OTT applications experience popularity changes over time which can include or otherwise be impacted by new OTT communication applications being introduced and users abandoning other OTT applications.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for providing a flexible OTT communication channel to be established on top of an existing communication network(s). In one or more embodiments, a telephone number is employed as a reliable and uniformed identity to connect different devices throughout the world by creating an architecture to allow the flexible OTT communication channel to be established on top of the existing communication network(s) such as per connection, per call, per application feature basis.

In one or more embodiments, an offer/answer or capability exchange over a network can be utilized to exchange or provide OTT application capabilities and/or priorities/preferences to allow for establishing a communication service (e.g., voice, video, messaging) via a particular OTT application that accommodates or is otherwise selected according to particular criteria, which can include preferences or prioritization (e.g., generated by the parties and/or stored at the parties' devices) among a group of OTT applications.

In one or more embodiments, Session Initiation Protocol (SIP) messaging can be utilized to exchange or provide OTT application capabilities and/or priorities/preferences, such as a calling party device utilizing a SIP invite via a network which includes (or otherwise delivers) a prioritized list of OTT applications that the calling party desires or otherwise prefers to utilize. In this example, the SIP invite can be received by equipment of the network and call control and routing can be performed by the equipment of the network to provide the SIP invite (along with the prioritized list of OTT applications (or a portion thereof)) to the called party device. In one or more embodiments, other types of discovery/messaging can be utilized (e.g., HTTP, TCP, SIP Options, SIP Subscribe/Notify) including other offer/answer protocols that would facilitate exchanging or providing prioritized list(s) for analysis to select an OTT application.

In one or more embodiments, a received prioritized list of OTT applications can be analyzed and compared with another prioritized list of OTT applications of the called party device (e.g., a prioritized list of OTT applications that the called party desires or otherwise prefers to utilize). This analysis and comparison, for example performed by the called party device, can be utilized to select a particular OTT application. Many different techniques for selecting a particular OTT application can be utilized, such as: selecting the top priority OTT application of the calling party if it appears on the called parties list; selecting the top priority OTT application of the called party if it appears on the calling parties list; selecting a compromise OTT application which may not be the top priority of either the calling or called party but is higher on both prioritized lists than other OTT applications; and so forth. In one or more embodiments, multiple matches may exist among the calling and called parties' prioritized lists of OTT applications and other factors can be utilized to select a particular OTT application amongst the lists, such as prior history of selection, historical or predicted performance of the OTT applications for providing the service, type of communication service, and so forth. Various devices, alone or in combination, can perform the analysis and comparison to select a particular OTT application including the called party device, the calling party device and/or a network device.

In one or more embodiments, a switching between OTT applications can occur during the communication service/session, such as according to the network service provider notifying devices to switch to a second matched OTT application based on various factors or triggers including a change in network conditions, a performance parameter for the OTT service falling below a threshold, and so forth. This can be performed in a number of different ways, including sending re-invite SIP messages. In one embodiment, the switch can be from the OTT service to a basic voice/video service provided by the telecom service provider.

Other factors that can be utilized in the generating of the prioritized list(s) and/or selection of the preferred OTT application can include identified relationships between the parties (e.g., work for same employer, attended same schools), security concerns/preferences such as based on type of communications (e.g., work-related conference vs social conversation), information obtained via query to the OTT application provider from the end user devices (e.g., current performance conditions, identification (which can include a confidence level) of parties involved such as to avoid spam calls, background checks on party, incentive/rewards from the OTT applications or from third party such as promoting use of a particular OTT application, and so forth). Other embodiments are described in the subject disclosure.

In one or more embodiments, it is also possible to have devices to exchange/discover OTT capabilities without establishing a voice call (via SIP Options, Subscribe/Notify). For example, an OTT application can be established without basic voice/messaging communication. However, in this embodiment, the user would lose the mid-call application control, for example, to be able to switch one OTT application to another OTT application without a disconnection.

In one or more embodiments, various information can be exchanged and/or discovered (e.g., during SIP messaging) which can be in addition to device identification information and/or OTT priority lists, such as device capabilities, costs associated with use of particular OTT services, SLA agreement requirements and provisions, community/entity/business/social relationships, context of the communication session, and so forth. As an example, a calling party may incur no charge to use a first OTT AR/VR service but a called party may incur a charge. This information can be exchanged or discovered, and can be factored into selection of the particular OTT AR/VR application that is to be utilized by the parties. For example, the information can be included in an initial message from a calling party device (e.g., a SIP invite sent to the network) and/or can be included in subsequent messaging between the calling party device and the network or the called party device and the network, which can result in the information being provided to the other party's device (e.g., via the network).

In one or more embodiments, the application discovery/negotiation process (e.g., SIP messaging although other techniques can be utilized as described herein) can include back and forth messaging (via the network) to discover particular information describing/regarding one or more of the other device(s), other user(s), other application(s) and so forth, including requesting specific information regarding a calling party to determine whether to participate in the OTT service such as whether a video call from a user is a legitimate call for business purposes or is a spam call. As another example, the application discovery/negotiation process can be utilized by one or more of the devices (e.g., calling party device, calling party device(s)) to perform a context evaluation, such as whether the OTT service will be for business activity rather than social activity. The context evaluation can be performed in a number of different ways, including adding context information to the messaging, requesting context information during the messaging, searching/evaluating received information during the messaging (e.g., receiving a device identification that indicates that the calling party device is associated with a supervisor of the called party), and so forth.

In one or more embodiments, the application discovery/negotiation process can be utilized to determine capabilities and/or differences between devices that can impact or otherwise influence which OTT application is to be selected, such as determining to utilize a first AR/VR OTT service because it requires less power usage of a device and it has been determined that one (or some or all) of the devices has relatively low power availability, limited power resources, or a low battery. Other device capabilities and differences can also be determined during the application discovery/negotiation process, such as sensor capability (e.g., a first device has a high resolution camera but the second device has a low resolution camera) which can influence or impact which OTT application would better serve both devices during the communication session.

In one or more embodiments, the application discovery/negotiation process can also be utilized to determine user preferences that can influence or impact which OTT application would better serve both devices during the communication session. As an example, a calling party device may have a preference for better audio capabilities while a called party device may have a preference for higher video capabilities, which can be discovered and can result in a selection of an OTT application that is a compromise as to audio and video quality that satisfies both devices/users. Other selection techniques can be employed which may or may not be a compromise between users/devices.

In one or more embodiments, the application negotiation/discovery process can discover application(s)-supported capabilities such as capability for multisensory communication, holographics, biometrics, and so forth, which for example can be in addition to determining device identification. In one or more embodiments, the application negotiation/discovery process can discover a community or other relationship of the calling and/or called parties which can be further utilized as a parameter for selection of an OTT application.

In one or more embodiments, the factors and parameters that are discovered during the application negotiation/discovery process (which can include discovery being made from the application or third party devices such as searching a database when a device identification is received to determine the context for the OTT service of the calling party request) can be a combination of factors which can be static or dynamic, including adding or removing factors and parameters based on various reasons such as factors and parameters that have been evaluated and determined to not be an accurate predictor of context or factors and parameters that have been evaluated and determined to result in user dissatisfaction with OTT application selection. Various ML/AI can be utilized in some or all of these techniques and processes.

In one or more embodiments, the devices (e.g., calling party device, called party device(s) and/or third party devices that are brought into or otherwise associated with the OTT session(s)) can utilize multiple applications at the same time (such as a voice OTT application and a video OTT application being utilized together). In one or more embodiments, the OTT selection process can include a selection of multiple OTT applications that are responsible for particular functions (which may or may not overlap), and which may or may not be aware that other OTT applications are performing the other functions. For example, a priority list can identify an order of video OTT applications, an order of audio OTT applications, and an order of augmented reality OTT applications where a device can support and execute all three OTT applications at a same time.

As another example, a communication device of a doctor can utilize the exemplary embodiments to select a first OTT application for obtaining a patient's bio-status remotely using multisensory communication (e.g., provided via a healthcare system, wearable sensors, sensors on the patients phone, etc.) while the doctor's device participates in a video call with the patient's phone via a second OTT application that was also selected by way of the exemplary embodiments. For instance, each of the OTT applications can be selected according to factors and parameters that are discovered during the application negotiation/discovery process.

In one or more embodiments, the devices can utilize multiple OTT applications at the same time through different communication sessions that are established utilizing the application negotiation/discovery process. As an example, the application negotiation/discovery process can be utilized to establish an AR/VR session for a patient via a first OTT application and establish a biometric monitoring session for the patient via a second OTT application so that the patient's biometric readings (e.g., heart-rate, pulse, reaction time, etc.) can be collected while the patient is engaged in the activity of the AR/VR session. In this example, the application negotiation/discovery process can be utilized to select a particular OTT application that provides AR/VR service and a particular OTT application that collects biometric readings.

In one embodiment for telemedicine, a healthcare provider device may support multiple OTT applications and services while different groups of patient devices support various OTT applications and services. In this example, the exemplary embodiments can be utilized to select, from a prioritized list(s) according to particular factor(s) or parameter(s), a particular one or more of the OTT applications and services for rendering the telemedicine to the particular patient.

In one or more embodiments, the application negotiation/discovery process can result in a determination that a device (e.g., a calling party device or a called party device(s)) does not have a particular OTT application(s). In this example, the device can refuse or reject the establishment of the OTT service or can download or otherwise acquire the OTT application, such as triggering a download of the particular OTT application during the application negotiation/discovery process (e.g., with the consent of the user of the device). This example can be implemented in various situations, including telemedicine where a patient's device may have the necessary sensors but has not downloaded the biometric OTT application for utilizing the sensors.

In one or more embodiments, various services and applications, including OTT services can be supported alone or in combination with each other including multisensory communications, social robots, holographic communication, digital twins, wearable haptics, brain computer interfaces, Internet of senses, telemedicine, and so forth.

One or more aspects of the subject disclosure include a device, comprising: a processing system including a processor; and a memory that stores executable instructions that, when executed by the processing system, facilitate performance of operations. The operations can include receiving, from a first end user device, identifications for a first group of OTT applications that are executable by the first end user device. The operations can include providing, to a second end user device, the identifications for the first group of OTT applications. The operations can include providing, to the first end user device, a first identification of a first OTT application of the first group of OTT applications. The operations can include facilitating establishing a communication session between the first and second end user devices utilizing the first OTT application.

One or more aspects of the subject disclosure include a non-transitory, machine-readable medium, comprising executable instructions that, when executed by a processing system including a processor of a first end user device, facilitate performance of operations. The operations can include generating a first prioritized list of OTT applications that are executable by the first end user device. The operations can include providing, to a network server, identifications for a first group of OTT applications from the first prioritized list. The operations can include obtaining a first identification of a first OTT application of the first group of OTT applications, where the obtaining is based at least in part on a match with a second prioritized list of OTT applications that are executable by a second end user device. The operations can include participating in a communication session with the second end user device utilizing the first OTT application.

One or more aspects of the subject disclosure include a method, comprising receiving, by a processing system including a processor, a first prioritized list of a first group of OTT applications that are executable by a first end user device. The method can include providing, to a second end user device, identifications for the first group of OTT applications. The method can include facilitating establishing a communication session between the first and second end user devices utilizing a first OTT application that is selected based at least in part on a match with a second prioritized list of OTT applications that are executable by the second end user device.

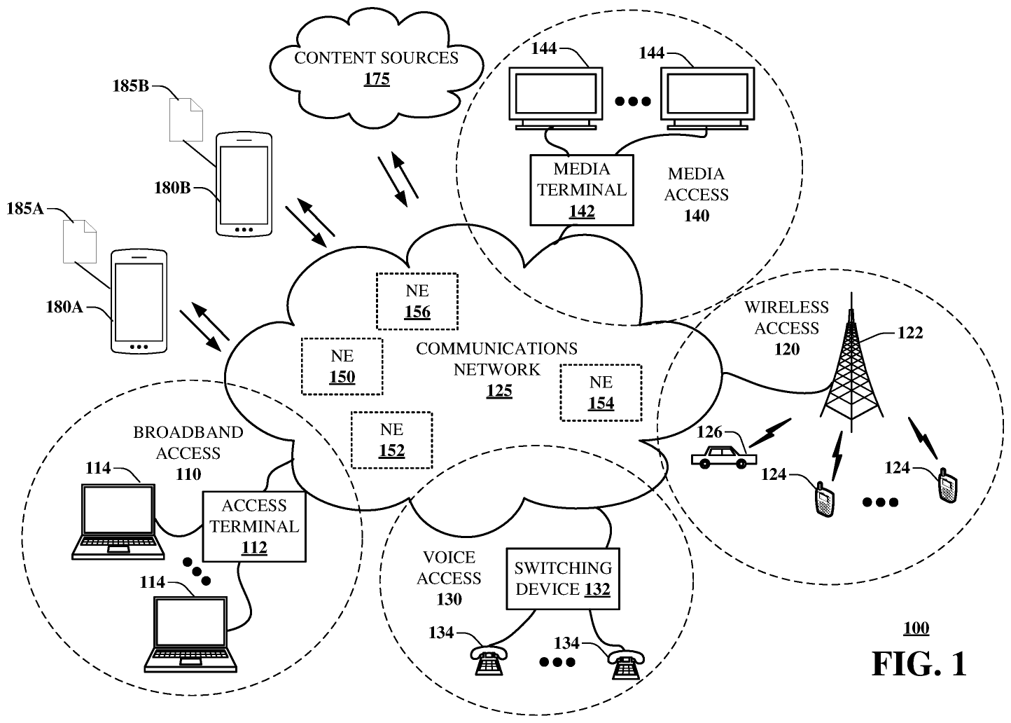

Referring now to FIG. 1, a block diagram is shown illustrating an example, non-limiting embodiment of a system 100 in accordance with various aspects described herein. System 100 can include various communication devices 180 (illustrated as a pair of mobile phones 180A, 180B but can include any number of devices, other types of devices, or combinations of other types of devices such as desktop computers, laptop computers, vehicle communication systems, smart TVs, or other devices that are capable of executing OTT applications for providing a service to an end user). In one or more embodiments, each of the devices 180 can store or otherwise access a prioritized list(s) 185 of OTT applications. In one embodiment, the prioritized list(s) 185 can include ranking in preferred order of usage. System 100 enables exchanging or otherwise providing the prioritized list(s), such as during an offer/answer mode provided by a network (e.g., SIP messaging) to facilitate analysis and comparison resulting in a selection of an OTT application that appears on both (or all for a service where more than two devices are participating). The selection of the preferred OTT application can be made by the called device 185B, the calling device 180A, other devices (e.g., a network server) or in combination such as agreement as to a selection by all devices participating on the communication service/session.

For example, system 100 can facilitate in whole or in part generating prioritized lists of OTT applications for end user devices, exchanging or otherwise providing the prioritized list(s) to enable analysis and comparison resulting in a selection of an OTT application, and establishing a communication service via the selected OTT application between the end user devices. In one or more embodiments, a base communication path (established during the application discovery process (e.g., SIP, or audio, or data channel)) can be maintained after the OTT application service is established which can be utilized in various ways including as a control signaling channel for the OTT application and/or as a separate user channel such as the OTT application providing video content (e.g., AR/VR content) while the base channel is used as an audio/voice call channel.

In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

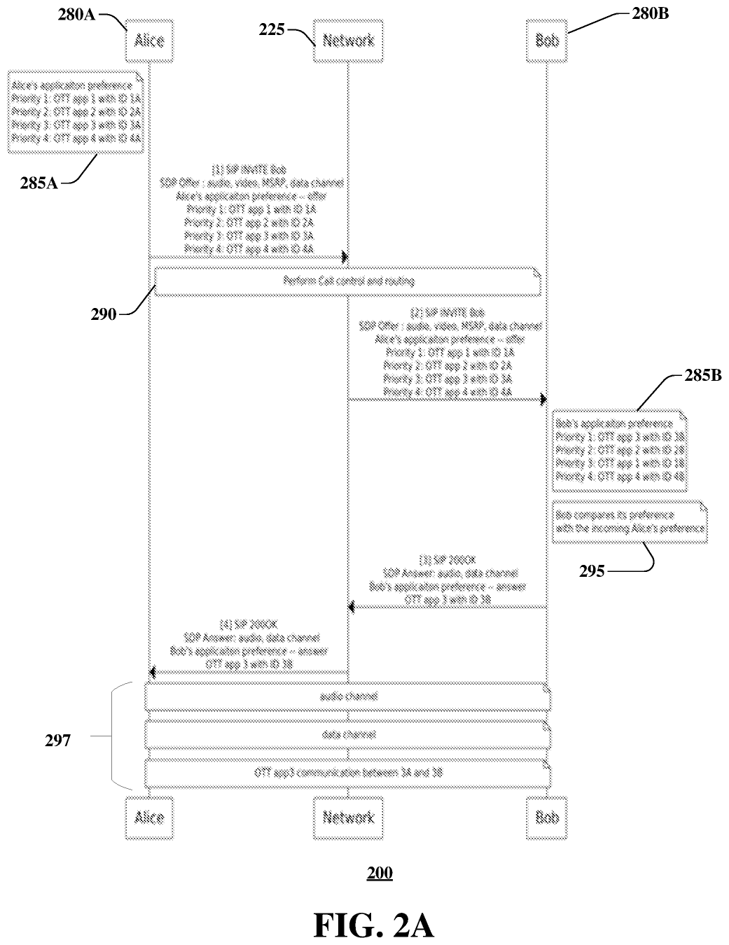

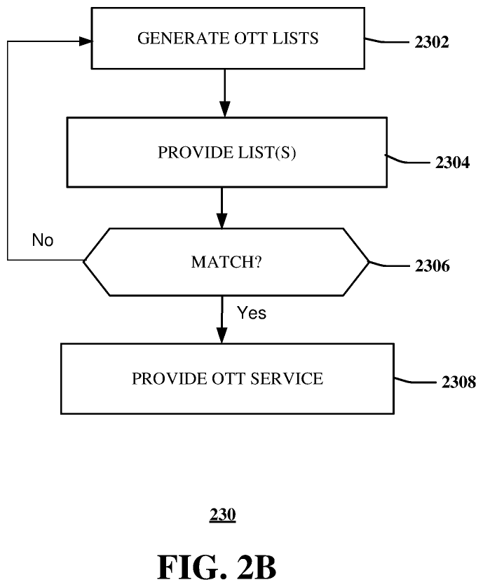

FIG. 2A is a block diagram illustrating an example, non-limiting embodiment of a flow 200 functioning within the communication network of FIG. 1 in accordance with various aspects described herein. Flow 200 is an example that utilizes SIP call set up as a base to exchange application capabilities to allow the endpoint to establish the best/preferred OTT application for communication that accommodates the preferences at both ends. Other embodiments can utilize other techniques for exchanging or providing a prioritized list(s), such as through a base communication path established by a network, which may or may not include SIP messaging. In this embodiment, a calling party device 280A (illustrated as Alice device) can support basic voice/video/messaging/MSRP calling and can generate or store a preferred list 285A of OTT applications capability, such as Priority 1: OTT app 1 with ID 1A; Priority 2: OTT app 2 with ID 2A; Priority 3: OTT app 3 with ID 3A; and Priority 4: OTT app 4 with ID 4A. A called party device 280B (illustrated as Bob device) can support basic voice/video/messaging/MSRP calling and can generate or store a preferred list 285B of OTT applications capability, such as Priority 1: OTT app 3 with ID 3B; Priority 2: OTT app 2 with ID 2B; Priority 3: OTT app 1 with ID 1B; and Priority 4: OTT app 4 with ID 4B. In this example, a SIP invite can be sent from device 280A to the network 225, which can include an extra field that is added to the standard SIP message protocol (application preference) to enable or otherwise facilitate negotiating the application capability/preference between parties. Other techniques for providing the prioritized list in conjunction with the SIP invite can also be utilized, such as a separate messaging scheme. The SIP invite causes or otherwise facilitates establishing call control and routing with the device 280B, such that the SIP invite (and prioritized list 285A) is forwarded to device 280B.

In this example, the OTT application selection can be performed by the called party device 280B as illustrated by reference 295, which can be based in part on the prioritized list 285B. In other embodiments, other techniques and/or other devices can perform the selection of the OTT application. In one embodiment, SIP messaging can be utilized to identify the selected OTT application, which is illustrated in SIP answer messages that are sent to the network 225 and then forwarded to the calling party device 280A. In one embodiment, after the standard SIP communication and following the offer/answer mode, in addition to the standard defined audio/video/msrp/data channel, a separate OTT application channel is created that allow the end users to have feature rich communication using their preferred OTT application, where the channel(s) are illustrated by reference 297.

In one embodiment, the base communication can be extended to any communication protocols that allows offer and answer exchange, such as, HTTP, WebRTC, etc., and may not be just limited to SIP. In one embodiment, the user and/or end user device can have full control of the application preferences, which can include dynamic modification based on user's needs and/or device capability or maybe locations.

In one embodiment, the application capability preference can be defined in detail by the users and/or the end user devices. For example, this can include any proprietary parameters that can further define the user's preference OTT application basis.

In one embodiment, the communication is not limited to point-to-point communications, but can also apply to multiparty applications. For example, three or more people may connect to a basic network voice conference bridge, where a “controller” or host of the conference, after the application capability exchange, can determine that all participants support a feature rich OTT conference service. In this example, he/she can initiate a new connection over the common OTT conference service.

In one embodiment, the base communication path that is established during the OTT application discovery process (e.g., SIP, or audio, or data channel) can still be present when the OTT application is established. The base communication path can continue to be utilized in a number of different ways, such as operating as a “control signaling” channel for the OTT application. In one embodiment, the end user devices (e.g., devices 280A and 280B) can use the audio channel (from the base communication path) for a voice call while using the OTT application for AR/VR communications. If there is an issue (e.g., a particular performance parameter is not being satisfied) with the OTT application such as an AR/VR application, then the devices 280A and 280B can use the established SIP session to re-negotiate another OTT application (e.g., app2 which is included in both prioritized lists 285A, 285B) for the AR/VR application.

It is also possible to have devices to exchanges/discovers OTT capabilities without establishing a voice call (via SIP Options, Subscribe/Notify). OTT application can be established without basic voice/messaging communication. However, in this way, the user would lose the mid call application control, for example, switch one OTT to another without disconnect.

In one embodiment, if the called party device does not support any OTT applications, the call/service can be established as the basic voice, video communication that the network/telecom provider offers.

One or more of the exemplary embodiments, facilitate conquering or alleviating digital divide and can ensure a successful communication with any device/user that has a telephone number (or any other unified recognized identifier supported globally, e.g., email addresses).

In one embodiment, telecom service providers can maintain some level of control on the OTT applications that are being allowed on their network. As an example, a telecom service provider can cause removal (e.g., via a border element) of a particular application (e.g., an OTT application that is prohibited from use or otherwise designated as not to be used on the network) from the OTT application preference/prioritized list(s). In this example, the removal can occur during the SIP or other discovery messaging process.

One or more of the exemplary embodiments, allow an end user (e.g., calling party) to utilize feature(s) of an OTT application according to that user's preference and according to the capability of the communication device of the other end user.

One or more of the exemplary embodiments, allow telecom service providers to use their existing network to offer interoperability to OTT services.

One or more of the exemplary embodiments, facilitate some level of control of usage on the network to be applied to a particular OTT application (e.g., an OTT application that is prohibited from use or otherwise designated as not to be used on the network), such as by the telecom service provider, a local authority, and so forth.

One or more of the exemplary embodiments, allow traditional telecom provider to maintain their presence in the marketplace and/or generate revenue from services that may be partially provided via the OTT application.

One or more of the exemplary embodiments provide an architecture that would automatically allow migration of OTT application's usage per the user's behavior.

One or more of the exemplary embodiments facilitate negotiation of a selected OTT application being done utilizing additional messaging between end user devices (e.g., two or more) via the network, such as counter-offer and counter-answer exchange when the initial offer message is not accepted (e.g., a new or revised prioritized list of OTT applications can be exchanged or provided including sending the revised prioritized list from the called party device to the calling party device via the equipment of the network).

In one or more embodiments, selection of the OTT application can be according to a list(s) where back-up OTT application(s) are also designated. For example, the analysis of the prioritized lists of the end user devices can result in a selection list that ranks the order that OTT applications are to be utilized for the communication service, which can include enabling switching to a first backup OTT application and then to a second back-up OTT application if certain thresholds are not satisfied (e.g., performance parameters, QoS thresholds). In this example, the monitoring of the thresholds can be performed by various devices alone or in combination such as the calling party device, the called party device, network equipment, etc. In another embodiment, the switching to the back-up OTT applications can be initiated by user input (e.g., alone or mutual consent of all parties), such as a user depressing an icon on the screen of the device if the user feels that the OTT application is not performing well or for some other user-based reasoning.

In one or more embodiments, the devices engaging in the OTT application discovery process (e.g., SIP messaging) can negotiate and agree on a selection technique to be employed, such as highest ranking matched OTT application.

In one or more embodiments, various other criteria can be implemented for selecting a particular OTT application from the prioritized lists including a recommendation of a third party (e.g., not affiliated with any of the OTT applications), the network, incentives/rewards being offered by the OTT applications. In one embodiment, incentives/rewards being offered by the OTT applications can be shared amongst the participants in the communication service/session.

In one or more embodiments, machine learning and/or artificial intelligence can be utilized for making various decisions including prioritizing OTT applications on a list(s), generating network recommendations for preferred OTT applications, and/or selecting from among matches on two or more lists (e.g., a three-way video call).

FIG. 2B depicts an illustrative embodiment of a method 230 in accordance with various aspects described herein. At 2302, prioritized lists of OTT applications can be generated for end user devices, such as a numbered/ranked/prioritized list of preferred OTT applications for delivering particular services. In one embodiment, multiple lists can be generated for each device, such as according to a type of service, device capability, a current geographical area, a time of day, and/or other factors. In one embodiment, the generated list(s) can be for a single end user device or can be shared amongst multiple devices of the user/family (e.g., where each of the devices has the particular OTT application installed or otherwise accessible). In one embodiment, the generated list(s) can be generated by the particular device storing/utilizing the list in a number of different ways, including according to user input, received recommendations (e.g., from a network provider), incentives/rewards, algorithm(s) that analyzes various factors (e.g., historical performance of the OTT application, network conditions, service type, device capability, and so forth), machine learning/artificial intelligence, or other techniques for selecting one or more preferred OTT applications (which can include ranking the OTT applications). In one embodiment, the generated list(s) can be generated by a different device (e.g., another device of the user, another device of a different user, a network device, and so forth) that provides the list to the particular device for storage and utilization.

At 2304, the prioritized list can be provided and/or exchanged to enable analysis and comparison. In one embodiment, the providing of the prioritized list can be done via a network providing a base communication path (e.g., SIP messaging or other offer/answer mode of connection). In one embodiment, the network (e.g., a network server) receives the prioritized list of a calling party and forwards or otherwise transmits it to the called party device. In one embodiment, this can be a one-way exchange such that the called party receives the calling party's prioritized list. In another embodiment, this can be a two-way exchange where the network provides a base communication path for delivering the prioritized lists to each end user device that will participate in the communication session/service.

At 2306, a selection of an OTT application can be performed. As an example, the prioritized lists of both the calling party and the called party can be analyzed for one or more matches. If a single match exists then that particular OTT application can be selected. If multiple matches exist then various techniques can be utilized to select among the multiple matches, including considering the ranking provided by one or both parties. The selection of the OTT application, such as through analysis of the prioritized lists for match(es) and/or according to other factors (e.g., network conditions, network recommendations, third party incentives/rewards, etc.) can be performed by the called party device or by one or more other devices, including the calling party device, a network device, or a combination of devices (e.g., a negotiation between the calling and called party devices). At 2308, a communication service can be established via the selected OTT application between the end user devices.

In one embodiment, identification can be provided, to a network server, for a first group of OTT applications from a first prioritized list; a first identification of a first OTT application of the first group of OTT applications can be obtained, where the obtaining is based at least in part on a match with a second prioritized list of OTT applications that are executable by a second end user device. In one embodiment, the obtaining the first identification of the first OTT application is from the network server according to a selection by the second end user device. In one embodiment, the providing the identifications for the first group of OTT applications and the obtaining the first identification of the first OTT application are based at least in part on SIP messaging. In one embodiment, the SIP messaging establishes a first channel for the first OTT application and establishes a second channel for control signaling. In one embodiment, the SIP messaging includes a field to negotiate application capability and/or preference between devices. In one embodiment, the established communication session includes a first channel for the first OTT application and a second channel associated with at least one of audio, video, messaging or data.

While for purposes of simplicity of explanation, the respective processes are shown and described as a series of blocks in FIG. 2B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

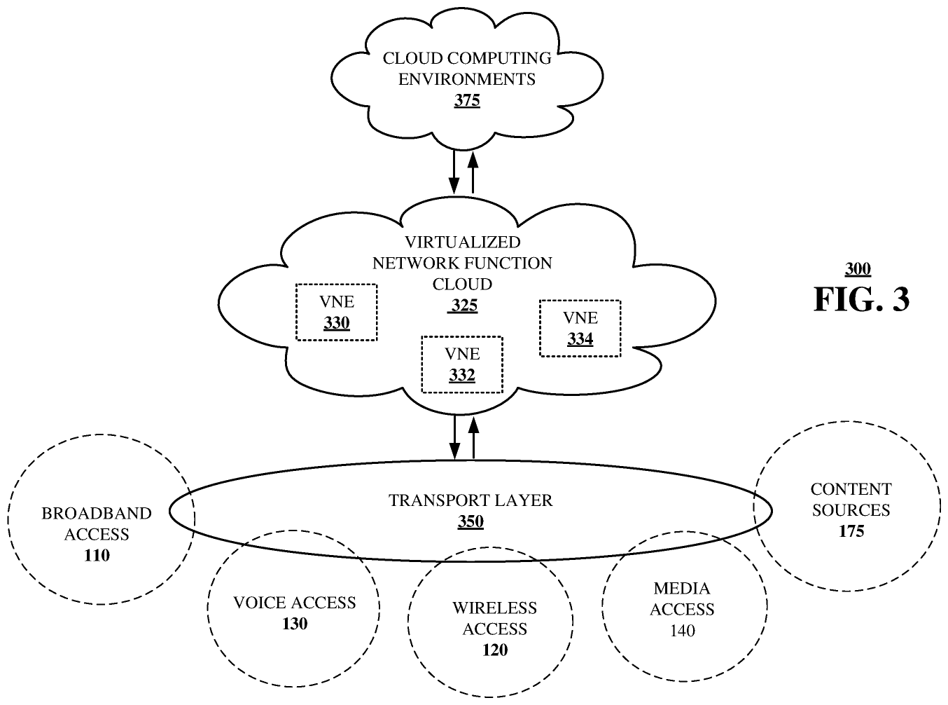

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200, and method 230 presented in FIGS. 1, 2A, 2B, and 3. For example, virtualized communication network 300 can facilitate in whole or in part generating prioritized lists of OTT applications for end user devices, exchanging or otherwise providing the prioritized list(s) to enable analysis and comparison resulting in a selection of an OTT application, and establishing a communication service via the selected OTT application between the end user devices. In one or more embodiments, a base communication path (established during the application discovery process (e.g., SIP, or audio, or data channel)) can be maintained after the OTT application service is established which can be utilized in various ways including as a control signaling channel for the OTT application and/or as a separate user channel such as the OTT application providing video content (e.g., AR/VR content) while the base channel is used as an audio/voice call channel.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

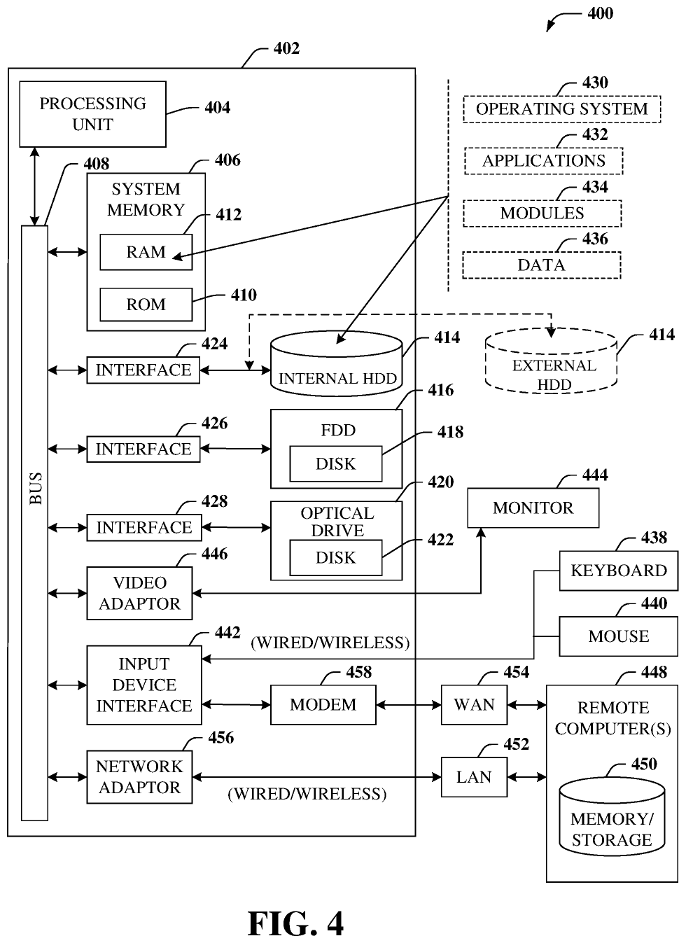

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part generating prioritized lists of OTT applications for end user devices, exchanging or otherwise providing the prioritized list(s) to enable analysis and comparison resulting in a selection of an OTT application, and establishing a communication service via the selected OTT application between the end user devices. In one or more embodiments, a base communication path (established during the application discovery process (e.g., SIP, or audio, or data channel)) can be maintained after the OTT application service is established which can be utilized in various ways including as a control signaling channel for the OTT application and/or as a separate user channel such as the OTT application providing video content (e.g., AR/VR content) while the base channel is used as an audio/voice call channel.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

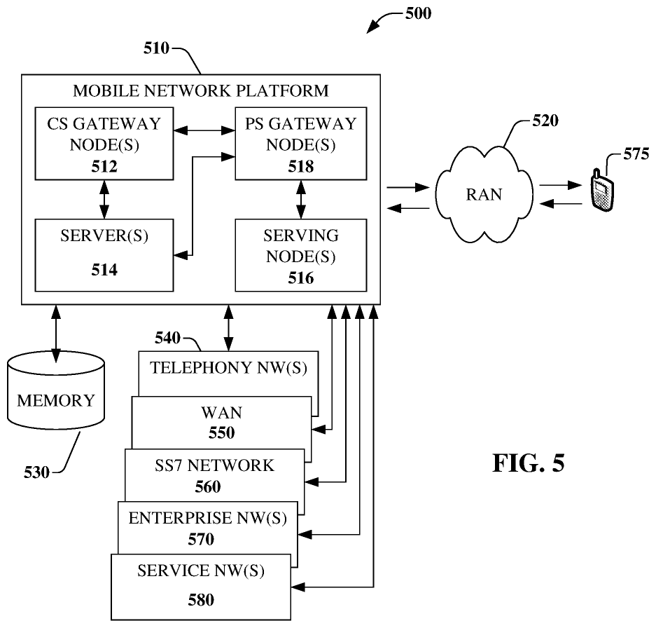

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part generating prioritized lists of OTT applications for end user devices, exchanging or otherwise providing the prioritized list(s) to enable analysis and comparison resulting in a selection of an OTT application, and establishing a communication service via the selected OTT application between the end user devices. In one or more embodiments, a base communication path (established during the application discovery process (e.g., SIP, or audio, or data channel)) can be maintained after the OTT application service is established which can be utilized in various ways including as a control signaling channel for the OTT application and/or as a separate user channel such as the OTT application providing video content (e.g., AR/VR content) while the base channel is used as an audio/voice call channel.

In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

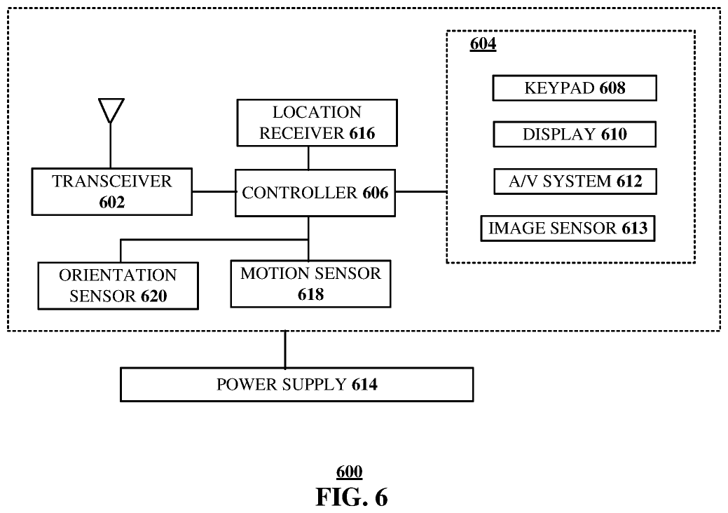

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part generating prioritized lists of OTT applications for end user devices, exchanging or otherwise providing the prioritized list(s) to enable analysis and comparison resulting in a selection of an OTT application, and establishing a communication service via the selected OTT application between the end user devices. In one or more embodiments, a base communication path (established during the application discovery process (e.g., SIP, or audio, or data channel)) can be maintained after the OTT application service is established which can be utilized in various ways including as a control signaling channel for the OTT application and/or as a separate user channel such as the OTT application providing video content (e.g., AR/VR content) while the base channel is used as an audio/voice call channel.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
receiving, from a first end user device, identifications for a first group of Over-The-Top (OTT) applications that are executable by the first end user device;
providing, to a second end user device, the identifications for the first group of OTT applications;
providing, to the first end user device, a first identification of a first OTT application of the first group of OTT applications; and
facilitating establishing a communication session between the first and second end user devices utilizing the first OTT application.

2. The device of claim 1, wherein the operations comprise:
receiving, from the second end user device, the first identification of the first OTT application, wherein the first identification of the first OTT application is selected by the second end user device according to a match in the first group of OTT applications executable by the first end user device and a second group of OTT applications executable by the second end user device.

3. The device of claim 2, wherein the communication session is one of a voice call, a video call or messaging, and wherein the first and second groups of OTT applications are prioritized lists stored by the first and second end user devices, respectively.

4. The device of claim 2, wherein the receiving the identifications for the first group of OTT applications, the providing the identifications for the first group of OTT applications, the providing the first identification of the first OTT application, and the receiving the first identification of the first OTT application are based at least in part on Session Initiation Protocol (SIP) messaging.

5. The device of claim 4, wherein the SIP messaging establishes a first channel for the first OTT application and establishes a second channel for control signaling.

6. The device of claim 4, wherein the SIP messaging includes a field to negotiate application capability and preference between devices.

7. The device of claim 1, wherein the facilitating the establishing the communication session includes establishing a first channel for the first OTT application, and wherein a second channel is established for a second OTT application for facilitating establishing a second communication session between the first and second end user devices at a same time as the communication session.

8. The device of claim 1, wherein the operations comprise:
receiving, from the second end user device, the first identification of the first OTT application, wherein the first identification of the first OTT application is selected by the second end user device according to a match in the first group of OTT applications executable by the first end user device and a second group of OTT applications executable by the second end user device, and wherein at least one of the first and second groups of OTT applications are prioritized lists that are generated by the first and second end user devices, respectively.

9. The device of claim 8, wherein the prioritized lists are generated based on queries performed by the first and second end user devices of the first and second groups of OTT applications, respectively.

10. The device of claim 1, wherein the operations comprise:
obtaining the first identification of the first OTT application, wherein the first identification of the first OTT application is selected by one of the first end user device, the second end user device or the processing system based at least in part on a match in the first group of OTT applications executable by the first end user device and a second group of OTT applications executable by the second end user device.

11. The device of claim 1, wherein the operations comprise:
receiving, from the second end user device, the first identification of the first OTT application, wherein the first identification of the first OTT application is selected by the second end user device based in part on a match in the first group of OTT applications executable by the first end user device and a second group of OTT applications executable by the second end user device and based in part on a recommendation of OTT applications generated by the processing system.

12. A non-transitory, machine-readable medium, comprising executable instructions that, when executed by a processing system including a processor of a first end user device, facilitate performance of operations, the operations comprising:
generating a first prioritized list of Over-The-Top (OTT) applications that are executable by the first end user device;
providing, to a network server, identifications for a first group of OTT applications from the first prioritized list;
obtaining a first identification of a first OTT application of the first group of OTT applications, wherein the obtaining is based at least in part on a match with a second prioritized list of OTT applications that are executable by a second end user device; and
participating in a communication session with the second end user device utilizing the first OTT application.

13. The non-transitory, machine-readable medium of claim 12, wherein the obtaining the first identification of the first OTT application is from the network server according to a selection by the second end user device.

14. The non-transitory, machine-readable medium of claim 12, wherein the providing the identifications for the first group of OTT applications and the obtaining the first identification of the first OTT application are based at least in part on Session Initiation Protocol (SIP) messaging.

15. The non-transitory, machine-readable medium of claim 14, wherein the SIP messaging establishes a first channel for the first OTT application and establishes a second channel for control signaling.

16. The non-transitory, machine-readable medium of claim 14, wherein the SIP messaging includes a field to negotiate application capability and preference between devices.

17. The non-transitory, machine-readable medium of claim 12, wherein the communication session includes a first channel for the first OTT application and a second channel associated with at least one of audio, video, messaging or data.

18. A method, comprising:
receiving, by a processing system including a processor, a first prioritized list of a first group of Over-The-Top (OTT) applications that are executable by a first end user device;
providing, to a second end user device, identifications for the first group of OTT applications; and
facilitating establishing a communication session between the first and second end user devices utilizing a first OTT application that is selected based at least in part on a match with a second prioritized list of OTT applications that are executable by the second end user device.

19. The method of claim 18, wherein the receiving the first prioritized list of the first group of OTT applications and the providing the identifications for the first group of OTT applications are based at least in part on Session Initiation Protocol (SIP) messaging, and wherein the receiving the first prioritized list includes receiving device capabilities of the first end user device.

20. The method of claim 18, wherein the first OTT application is selected by the second end user device.
